(19) United States
(12) Patent Application Publication
(10) Pub. No.: US 2010/0305793 A1
(43) Pub. Date: Dec. 2, 2010

(54) METHOD FOR STARTING A HYBRID ELECTRIC VEHICLE

(75) Inventors: Kevin S. Kidston, New Hudson, MI (US); Jonathan R. Schwarz, Clawson, MI (US); Adam B. Sloan, Brighton, MI (US); Emily R. Wu, New Hudson, MI (US)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/476,357

(22) Filed: Jun. 2, 2009

(51) Int. Cl. G06F 19/00

(52) U.S. Cl. 701/22; 180/65.21

(57) ABSTRACT

A method of starting a hybrid electric vehicle when a low voltage battery used for starting the vehicle has a depleted charge and a high voltage battery used for propelling the vehicle has ample charge to share. Assuming that other factors are satisfied, the system and method described herein may enable the high voltage battery to provide the low voltage battery with enough charge so that it is able to start an internal combustion engine but not so much charge that it undesirably drains the high voltage battery to a point where it cannot be replenished.

### TECHNICAL FIELD

The present invention generally relates to vehicles having more than one battery and, more particularly, to methods for starting vehicles like hybrid electric vehicles (HEV) that include separate high and low voltage batteries.

### BACKGROUND

Hybrid-electric vehicles generally include an internal combustion engine and an electric motor that cooperate with one another to provide power to the vehicle. A high voltage battery can provide a current/voltage combination capable of powering the electric motor, which in turn can propel the vehicle. Some applications include an additional low voltage battery, traditionally 12 V, which can be dedicated to other vehicle power demands. As an example, the low voltage battery may be used for starting the internal combustion engine.

If the condition of the additional low voltage battery deteriorates and its charge level falls below a certain threshold, it may not be able to fulfill the vehicle's other power demands.

### SUMMARY

According to one embodiment, there is provided a method for starting a hybrid electric vehicle. The method may comprise the steps of: (a) determining the status of a high voltage battery unit used for vehicle propulsion; (b) determining the status of a low voltage battery unit used for starting the hybrid electric vehicle; (c) determining if a user is attempting to start the hybrid electric vehicle; and (d) if the status of the high voltage battery unit indicates that it is able to provide charge, the status of the low voltage battery unit indicates that it is in need of charge, and the user is attempting to start the hybrid electric vehicle, then providing charge from the high voltage battery unit to the low voltage battery unit to assist with starting the hybrid electric vehicle.

According to another embodiment, there is provided a method for starting a hybrid electric vehicle. The method may comprise the steps of: (a) determining the status of a high voltage battery unit used for vehicle propulsion; (b) determining the status of a low voltage battery unit for starting the hybrid electric vehicle; (c) if the status of the high voltage battery unit indicates that it is able to provide charge and the status of the low voltage battery unit indicates that it is in need of charge, then providing charge from the high voltage battery unit to the low voltage battery unit to assist with starting the hybrid electric vehicle; and (d) monitoring one or more charge transfer conditions and using the charge transfer condition to automatically stop the provision of charge from the high voltage battery to the low voltage battery without further input from a user.

According to another embodiment, there is provided a system for use in a hybrid electric vehicle. The system may comprise: a high voltage battery unit; a first set of sensors coupled to the high voltage battery unit; a low voltage battery unit; a second set of sensors coupled to the low voltage battery unit; an ignition unit coupled to the low voltage battery unit; a power module coupled to the high and low voltage battery units; and a control module coupled to the first set of sensors, to the second set of sensor, to the ignition unit, and to the power module. If a high voltage battery signal indicates that the high voltage battery unit is able to provide charge, a low voltage battery signal indicates that the low voltage battery unit is in need of charge, and an ignition signal indicates that the hybrid electric vehicle is experiencing a starting event, then the control module uses a command signal to instruct the power module to provide charge from the high voltage battery unit to the low voltage battery unit.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a block diagram depicting at least part of an exemplary hybrid electric vehicle (HEV); and

FIG. 2 is a flow chart illustrating some of the steps of an exemplary method for starting a hybrid electric vehicle, such as the exemplary one illustrated in FIG. 1.

### DETAILED DESCRIPTION OF THE PREFERRED EMBODIMENTS

Hybrid electric vehicles (HEV) can be described as vehicles that include two or more sources of power in the vehicle powertrain. A hybrid electric vehicle may include one or more electric motors and an internal combustion engine (ICE), for example, where each of these sources of power is coupled to a hybrid transmission. A number of different hybrid electric vehicle designs are known, including plug-in hybrids, serial hybrids, parallel hybrids, and mixed hybrids, to cite a few. Although the following description is provided in the context of an exemplary parallel hybrid system, it should be appreciated that the system and method described herein may be used with any vehicle having multiple batteries and is not limited to the exemplary embodiment described below. The present system and method may even be used with vehicles having fuel cells and/or electric vehicles that run exclusively on batteries.

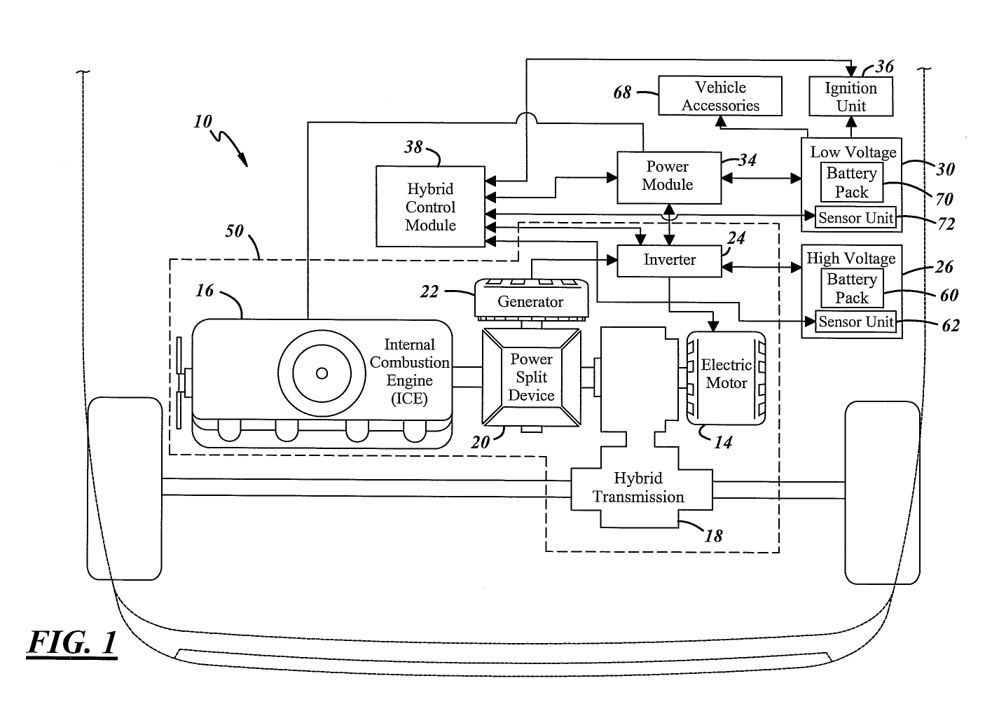

With reference to FIG. 1, there is shown an exemplary parallel hybrid system 10 for use in a hybrid electric vehicle (HEV). According to this exemplary embodiment, system 10 includes one or more electric motors 14, an internal combustion engine (ICE) 16, a hybrid transmission 18, a power split device 20, a generator 22, an inverter 24, a high voltage battery unit 26, a low voltage battery unit 30, power module 34, an ignition unit 36, and a hybrid control module 38. Skilled artisans will appreciate that exemplary system 10 may include more, less or a different combination of components, devices and/or modules than those schematically shown here, and that the present system and method is not limited to this particular embodiment. One or more of the components, devices and/or modules shown in FIG. 1 may be integrated or otherwise combined with other parts of the hybrid electric vehicle, as the block diagram in that figure is only meant to generally and schematically illustrate one potential hybrid system arrangement.

Generally, hybrid system 10 uses electric motor 14 and/or ICE 16 to drive the vehicle wheels via an exemplary hybrid drivetrain 50. The hybrid drivetrain 50 shown here generally includes one or more electric motor(s) 14, ICE 16, hybrid transmission 18, power split device 20, generator 22 and inverter 24. Because each of these components is generally known and understood in the art, a brief explanation of the exemplary hybrid drivetrain components has been provided in lieu of a detailed recitation of their structure and functionality.

Electric motor 14 propels the hybrid electric vehicle using electric power stored in high voltage battery unit 26, and may include any type of suitable electric motor known in the art. While FIG. 1 schematically depicts electric motor 14 as a discrete device, other embodiments including those that incorporate or otherwise combine the electric motor with the hybrid transmission, generator, etc. may also be used. ICE 16 propels the hybrid electric vehicle using conventionally combustion techniques, and may include any suitable type of engine known in the art. Some examples of suitable engines include gasoline, diesel, ethanol and flex-fuel engines, as well as variants of the internal combustion engine such as the rotary engine. Hybrid transmission 18 and power split device 20 help transfer mechanical output from electric motor 14 and/or ICE 16 to the vehicle wheels, as well as from the vehicle wheels to generator 22. For example, power split device 20 can selectively direct power from ICE 16 to hybrid transmission 18 during vehicle propulsion, and can direct power from the vehicle wheels to generator 22 during regenerative braking. Generator 22 uses mechanical motion provided by power split device 20 to generate electrical power for charging high voltage vehicle battery 26, for operating electrical accessories within the vehicle, etc. Any number of suitable generators known in the art may be used. Inverter 24 converts energy in one form to another form and transmits the converted energy to a destination such as high voltage vehicle battery 26 or electric motor 14 (e.g., AC power from generator 22 may be converted into DC power for high voltage battery unit 26). Again, the preceding description of exemplary hybrid drivetrain 50 is only intended to illustrate one potential hybrid arrangement and to do so in a general way. Any number of other hybrid arrangements, including those that significantly differ from the one shown in FIG. 1, may be used instead.

High voltage battery unit 26 stores energy that may be used to propel the hybrid electric vehicle via electric motor 14, and may be of any suitable battery type known in the art. For instance, examples of suitable battery types include all types of lithium-ion (e.g., lithium iron phosphate, lithium nickel manganese cobalt, lithium iron sulfide and lithium polymer, etc.), lead-acid, advanced lead-acid, nickel metal hydride (NiMH), nickel cadmium (NiCd), zinc bromide, sodium nickel chloride (NaNiCl), zinc air, vanadium redox, and others. According to an exemplary embodiment, high voltage battery unit 26 includes a lithium-ion battery pack 60 having a number of individual battery cells and a sensor unit 62. The battery pack 60 may provide approximately 40-600 V, depending on its particular design and application. For example, a heavy vehicle using a two-mode hybrid system may require a high voltage battery pack capable of providing about 500 V, where a lighter vehicle may only need about 200 V. In another embodiment, the hybrid system 10 may be a belt-alternator-starter (BAS) or BAS-plus type system and thus only require a battery pack that provides about 40-110 V. In any case, battery pack 60 may be designed to withstand repeated charge and discharge cycles and can receive electrical energy from generator 22 through inverter 24. The battery pack 60 may provide electrical energy to electric motor 14 through inverter 24 or it may provide energy to the motor directly, for example.

Sensor unit 62 may monitor, evaluate, control, manage, etc. certain charging and/or discharging functions related to battery pack 60. In one exemplary embodiment, sensor unit 62 is a battery pack control module (BPCM) that is integrated within high voltage battery unit 26 and includes one or more sensor(s) coupled to battery pack 60, as well as processing and memory resources. The sensors, which may include status, voltage, current, load, temperature and/or any other suitable battery sensor, can provide information and data that can be processed by the sensor unit and/or forwarded on to other devices, components, modules, etc. in the system. For example, various battery sensor readings can be gathered, processed and saved by sensor unit 62 and then transmitted to hybrid control module (HCM) 38 in the form of a high voltage battery signal. Although battery pack 60 and sensor unit 62 are schematically shown here as being integrated into a single component, it should be appreciated that other embodiments can involve mounting the sensor unit external to the battery pack and connecting the battery pack-mounted sensors to the sensor unit via some type of communication medium, for example.

Low voltage battery unit 30 stores energy that may be used to perform secondary or auxiliary functions within the hybrid electric vehicle, such as starting the ICE 16 via ignition unit 36 or powering certain low voltage vehicle accessories 68. According to an exemplary embodiment, low voltage battery unit 30 includes a battery pack 70 (e.g., a traditional 12 V or 42 V lead-acid battery) and one or more battery sensors 72, and may be of any suitable battery type known in the art. In one application, low voltage battery unit 30 energizes a solenoid and/or a starter motor (not shown) that turns a crankshaft in ICE 16; that is, the low voltage battery unit provides the energy for starting the engine. In another application, low voltage battery unit 30 powers one or more vehicle accessories 68. Examples of potential low voltage accessories include a radio receiver, DVD player, television, telematics unit and/or other infotainment devices, as well as vehicle interior or exterior lights, auxiliary power plugs, etc. These are, of course, only some of the potential vehicle accessories that may be powered by low voltage battery unit 30. While an exemplary low voltage battery unit has been discussed, others batteries, materials, designs, embodiments, etc. could be used with equal success.

Sensor unit 72 may monitor, evaluate, control, manage, etc. certain charging and/or discharging functions related to battery pack 70. In one exemplary embodiment, sensor unit 72 includes one or more sensor(s) coupled to battery pack 70, as well as processing and memory resources. The sensors, which may include status, voltage, current, load, temperature and/or any other suitable battery sensor, can provide information and data that can be processed by the sensor unit and/or forwarded on to other devices, components, modules, etc. in the system. For example, various battery sensor readings can be gathered, processed and saved by sensor unit 72 and then transmitted to hybrid control module (HCM) 38 in the form of a low voltage battery signal. Although battery pack 70 and sensor unit 72 are schematically shown here as being integrated into a single component, it should be appreciated that this is only one potential configuration. For example, sensor unit 72 could be separated from battery pack 70, could be integrated with sensor unit 62, or provided according to some other arrangement. Any suitable battery sensing arrangement known in the art may be used with the high and low voltage battery units 26 and 30.

It should be appreciated that the terms “high voltage battery unit” and “low voltage battery unit” are not limited to any particular voltage rating. Instead, these terms are relative in that battery pack 60 of high voltage battery unit 26 generally has a higher voltage than battery pack 70 of low voltage battery unit 30. Therefore, while some preferred voltage ratings and ranges are provided above for purposes of illustration, the system and method described herein are not limited to such embodiments.

Power module 34 couples high and low voltage battery units 26 and 30 together, and may perform a number of different functions in that capacity. In an exemplary embodiment, power module 34 is an accessory power module (APM) that is electrically coupled to high and low voltage battery units 26, 30 and inverter 24 for the exchange of electrical energy, as well as to hybrid control module 38 for providing a power module signal. Power module 34 may include any combination of processing and memory resources, as well as transformers and/or other electrical components used for transmitting or exchanging electrical energy between different components, devices, modules, etc. of hybrid system 10. Some examples of possible power module functions include stepping down DC power from inverter 24 and using it to charge low voltage battery unit 30, and stepping down DC power from high voltage battery unit 26 and using it to charge the low voltage battery unit; this second function will be subsequently explained in more detail. In some embodiments, power module 34 can be thought of as a replacement for a traditional vehicle alternator except that it can provide energy to low voltage battery unit 30 even when the vehicle engine is off. It is possible for power module 34 to be combined or otherwise integrated with inverter 24, for example.

Ignition unit 36 allows an operator to control the overall status of the hybrid system 10, such as whether the vehicle is ‘on’ or ‘off’. For example, ignition unit 36 may include a traditional ignition slot for a vehicle key where the status of the vehicle is dependent on the position of the key (e.g., the vehicle key can be turned through ‘accessory’, ‘off’, ‘on’ and ’start’ positions or settings). An ‘accessory’ setting may indicate that the hybrid system 10 is not currently capable of providing propulsion via electric motor 14 and/or ICE 16 but can provide power to certain vehicle accessories 68; an ‘on’ setting may indicate that the hybrid system is currently operating or is capable of operating the electric motor and/or ICE; an ‘off’ setting may indicate that the hybrid system is currently neither operating the electric motor and/or the ICE nor is it capable of doing so; and the ‘start’ setting may indicate that an operator and/or some device is starting or is attempting to start the ICE via ignition unit 36. The ignition unit 36 can be a mechanical unit that uses a key-activated switch, as explained above, or it can be a mainly electrical unit that includes a push button, biometric sensor, proximity sensor, etc. Ignition unit 36 may include any ignition arrangement—keyed, keyless or otherwise—known in the art, and it may provide an electronic ignition signal that is representative of the status of ignition unit 36 (e.g., the ignition signal could indicate the current setting or status of ignition unit 36). The ignition signal could be provided to sensor unit 72, hybrid control module 38, or to some component, device, module, etc. in hybrid system 10.

Hybrid control module 38 gathers information from all around hybrid system 10 and may execute one or more electronic instructions saved in software, firmware, etc. to control certain aspects of the hybrid system's operation. In one exemplary embodiment, hybrid control module 38 includes processing resources (e.g., a microprocessor, a microcontroller, an application specific integrated circuit (ASIC), etc.) and memory resources. The hybrid control module 38 can be electronically coupled to high voltage battery unit 26 for receiving a high voltage battery signal, to low voltage battery unit 30 for receiving a low voltage battery signal, to power module 34 for receiving a power module signal, to ignition unit 36 for receiving an ignition signal, and to the other devices in hybrid system 10 for providing command and other instructions. Of course, hybrid control module 38 may be coupled to and/or receive information from other components, devices, modules, etc., and hybrid control module 38 may be integrated or otherwise combined with other parts of the hybrid electric vehicle. In one example, the hybrid control module includes a hybrid control processor (HCP) and is coupled to an engine control module (not shown).

As explained above, it should be appreciated that the exemplary hybrid system 10 shown in FIG. 1 is only a general and schematic illustration of one potential hybrid system. The method described herein may be used with any number of vehicle systems and is not limited to the specific one shown here.

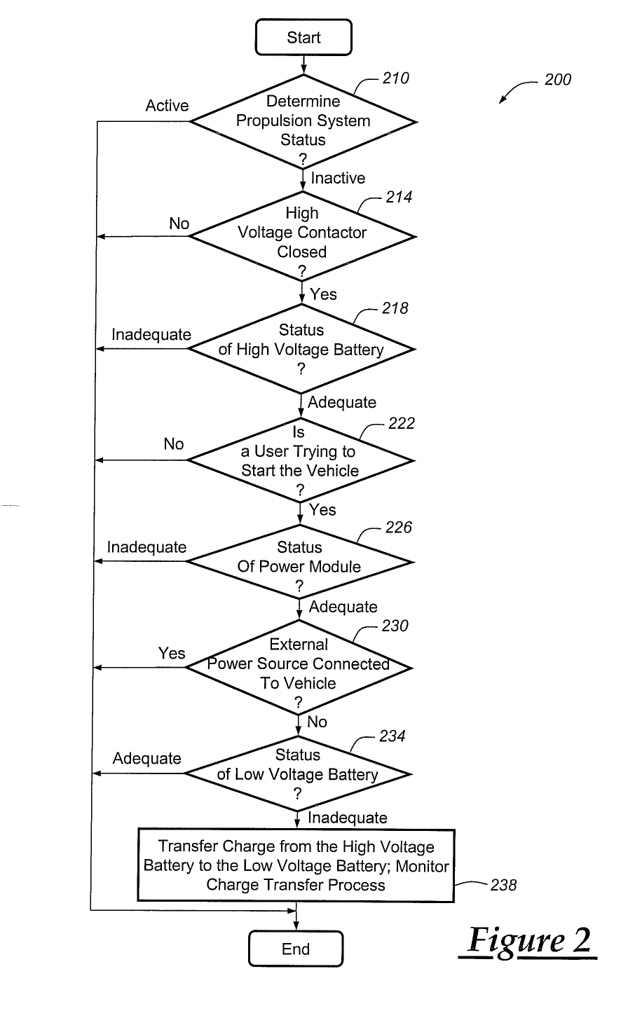

Turning to FIG. 2, an exemplary method is provided for starting a hybrid electric vehicle. It is possible for the charge level on the low voltage battery unit 30 to fall to such a level that it is unable to start ICE 16, while the charge level on the high voltage battery unit 26 remains high. Assuming that other factors are satisfied, the system and method described below may enable the high voltage battery to provide the low voltage battery with enough charge so that it is able to start the ICE, but not so much charge that it undesirably drains the high voltage battery to a point where it cannot be replenished. Put differently, the present system and method may regulate the transfer of power from a high voltage or propulsion battery to a low voltage or auxiliary battery during a starting event. According to one embodiment, the present method has as little impact as possible on the other vehicle systems and processes (e.g., it does not affect the normal charging processes for the high and low voltage batteries, nor does it affect the key or ignition start procedures), and the method transfers charge in an optimum fashion (e.g., it automatically disables once the low voltage battery has enough charge for a starting event).

It is not necessary that high voltage battery 26 only provide energy for purposes of vehicle propulsion and that low voltage battery 30 be directly responsible for starting the internal combustion engine. In some embodiments, high voltage battery 26 may provide the energy for both vehicle propulsion and for starting the internal combustion engine, and low voltage battery 30 may provide the energy for controllers, modules, high voltage contactors, and other devices that need to be active in order to start the hybrid electric vehicle. For instance, low voltage battery 30 may need to energize high voltage contactors or the like in order for the vehicle to start, even though the low voltage battery is not actually providing the energy to ignition unit 36 for starting the engine. In such a case, the present method can provide energy from high voltage battery 26 to low voltage battery 30 so that the low voltage battery can turn on such critical devices that are necessary for engine start-up. This embodiment still employs a “high voltage battery that is used for vehicle propulsion” and a “low voltage battery that is used for starting the hybrid electric vehicle,” albeit in a somewhat different arrangement than that described below.

The method 200 for starting a hybrid electric vehicle begins at step 210, which involves determining a propulsion system status. If the propulsion system is already ‘active’, then this step may avoid transferring charge from high voltage battery unit 26 to low voltage battery unit 30 so as to not interfere with the normal charging process of the high and/or low voltage batteries. Typically, one or more batteries are already being charged if the propulsion system is active. A variety of different methods and techniques may be used to determine the propulsion system status. These include, for example, receiving a power module signal from power module 34 (usually, the power module is only ‘on’ when the propulsion system is active); receiving an ignition signal from ignition unit 36 (indicates if the ignition is in the ‘on’ or ‘start’ position); checking the operational status of electric motor 14 and/or ICE 16; and/or receiving information from any other suitable source in the hybrid electric vehicle and using that information to determine the propulsion system status. Any known method or technique for determining propulsion system status may be used. If the propulsion system is ‘active’, then method 200 may end; if the propulsion system is ‘inactive’, then the method may proceed to step 214.

At step 214, the method determines the status of one or more high voltage contactors. Skilled artisans will appreciate that high voltage contactors are devices, such as relays, that connect and disconnect battery pack 60 in high voltage battery unit 26 with the rest of the hybrid electric vehicle. These devices may be mounted internal or external to the high voltage battery unit 26. If the high voltage contactors are open, such as the case when a malfunction is detected or after the vehicle has been turned ‘off’ for a certain amount of time, the high voltage battery unit 26 cannot provide energy to other elements in the vehicle—this includes low voltage battery unit 30—and method 200 ends. If the contactors are closed, which is usually the case during normal operation, then method 200 continues to step 218.

At step 222, the method determines the status of the high voltage battery unit 26, which is preferably used for vehicle propulsion. The status of the high voltage battery unit, and more specifically battery pack 60, should be checked to ensure that it has enough energy to provide charge to low voltage battery unit 30. If high voltage battery unit 26 is experiencing a depletion in its charge or some other undesirable condition, then it may not be in a strong or healthy enough state to provide energy to the low voltage battery unit 30. In one embodiment, sensor unit 62 sends a high voltage battery signal to hybrid control module 38 that communicates the status of the high voltage battery unit, and the hybrid control module uses this information to determine if the high voltage battery is in an adequate or inadequate state to be providing charge to the low voltage battery.

A variety of measurements, factors, metrics, thresholds, etc. may be used singly or in combination for this status evaluation. For example, minimum and/or maximum voltage levels (e.g., represented as a percentage of a total voltage or as an absolute voltage) may be established for battery pack 60 (e.g., the voltage on battery pack 60 must be greater than 20-30% of its overall voltage capacity). Similar thresholds may be applied to a particular collection or grouping of cells within battery pack 60, as opposed to the battery pack as a whole. If the voltage on the high voltage battery is outside of the acceptable range, then method 200 may prevent the high voltage battery from charging the low voltage battery. These voltage thresholds, which may be calibrated during vehicle development, can be saved in the memory of sensor unit 62, power module 34, hybrid control module 38 and/or some other location. Other examples of criteria or metrics that may be used to determine the status of high voltage battery unit 26 include battery current, state of charge (SOC) (e.g., the SOC must be greater than 20-30%), state of health (SOH) and/or any other suitable parameter. Any known technique for determining these or other parameters may be used. If the status of the high voltage battery unit is adequate or sufficient for charge transfer, then the method proceeds to step 226; if the status is inadequate or insufficient, then the method ends.

Step 222 determines if a user is attempting to start the hybrid electric vehicle. A user can attempt to start the vehicle or cause system 10 to become operational in a variety of different ways, including by engaging ignition unit 36. As explained above, the status of ignition unit 36 is usually dictated by the user and can vary between ‘accessory’, ‘on’, ‘off’, or ‘start’ settings, for example. When the ignition unit 36 is set to ‘off’ or ‘accessory’, the user is generally not attempting to start or crank ICE 16. However, if the user turns or otherwise engages ignition unit 36 so that it is in the ‘on’ or ‘start’ position, then the user may be attempting to start the vehicle. In one example, ignition unit 36 sends an electronic ignition signal to hybrid control module 38 that communicates the status of the ignition unit or starting events in general, and the hybrid control module uses this information to determine if a user is attempting to start the vehicle. If the user is not attempting to start the vehicle, then method 200 may end; if the user is attempting to start the vehicle, then the method may proceed to step 218. According to this embodiment, method 200 is only performed when a user is attempting to start the vehicle.

At step 226, the method checks the status of power module 34 to determine if it is functioning properly. The power module should be in a healthy state and/or functioning normally if it is to help transfer electrical energy from high voltage battery unit 26 to low voltage battery unit 30. In some implementations, electrical energy from high voltage battery unit 26 is stepped down and routed through power module 34 before being provided to low voltage battery unit 30, as already explained. Thus, the operational status of power module 34 should be checked and confirmed being using it to transfer charge from the high voltage battery to the low voltage battery. In an exemplary embodiment, hybrid control module 38 receives a power module signal from power module 34 that indicates its operational status. If the status of power module 34 is inadequate or otherwise unsatisfactory, then method 200 can end without transferring energy from the high voltage battery to the low voltage battery. If, however, the power module status is adequate or sufficient, the method 200 may proceed.

Step 230 determines if some other charge transfer process is underway. For example, a vehicle user may connect an external power source—such as an additional 12 V battery for ‘jumpstarting’ the vehicle—to the hybrid electric vehicle to add energy to high voltage battery unit 26 and/or low voltage battery unit 30. If a charge transfer event like this is already in progress, then method 200 may not want to try and transfer charge from the high voltage battery to the low voltage battery, as these processes may conflict with one another. Power module 34 and/or hybrid control module 38, for instance, may include sensors that can determine if an external power source is connected to the vehicle. If the user has already connected an external power source to the hybrid electric vehicle, then method 200 ends. If not, the method proceeds to step 234.

At step 234, the method determines the status of low voltage battery unit 30, which is preferably used for starting the vehicle and/or powering other functions. The status of low voltage battery unit 30, and more particularly battery pack 70, may be used to determine if the low voltage battery is in need of charge. If low voltage battery unit 30 is charged to a sufficiently high level or is in a generally healthy condition, then it likely does not need energy from high voltage battery unit 26. Skilled artisans will appreciate that a variety of measurements, factors, metrics, thresholds, etc. may be used singly or in combination to evaluate the status of low voltage battery unit 30. For example, a maximum voltage level may be established for battery pack 70 (e.g., the voltage on battery pack 70 must be less than 20-30% of its overall capacity in order for method 200 to be available). These voltage thresholds, which may be empirically determined or calibrated during vehicle development or dynamically determined through the course of vehicle use, can be saved in memory in sensor unit 72, power module 34, hybrid control module 38 and/or some other location. Other examples of measurements that can be used to determine the status of low voltage battery unit 30 include the battery current, the state of charge (SOC) and/or the state of health (SOH). If step 234 reveals that the current status of low voltage battery unit 30 is adequate or otherwise satisfactory, then method 200 ends (there is no need to transfer charge away from the high voltage battery if the low voltage battery is not in need of it). If the low voltage battery unit is in need of charge, then the method proceeds to step 238.

At step 238, assuming that all of the appropriate preconditions have been met, charge is transferred from high voltage battery unit 26 to low voltage battery unit 30 to help start the hybrid electric vehicle. According to one embodiment, hybrid control module 38 manages or otherwise controls the charge transfer process from the high voltage battery to the low voltage battery, and does so automatically when the above-described criteria are met (i.e., step 238 automatically initiates and oversees the charge transfer process without any further action by the user). There are a number of different ways in which the charge could be transferred from the high voltage to the low voltage battery. In one example where power module 34 outputs a fairly constant DC voltage (e.g., 12-16V), hybrid control module 38 sends a command signal to the power module which causes it to vary the duty cycle of its current output. This command signal could call for a static, unchanging duty cycle, or the command signal could call for a dynamic, changing duty cycle that alters according to the electrical needs of the vehicle, battery, etc. Of course, it is also possible for the command signal in step 238 to control some other aspect of the power output, in addition to or in lieu of the current duty cycle.

While energy is being transferred from high voltage battery unit 26 to low voltage battery unit 30, one or more charge transfer conditions may be monitored—continuously, periodically or otherwise—in order to ensure that no changes have occurred that could negatively impact the charge transfer process. In one example, some combination of steps 210-234 are monitored on an ongoing basis while the high voltage battery delivers charge to the low voltage battery. If any of these charge transfer conditions change and result in a fault condition (e.g., high voltage battery or power module status changes from ‘adequate’ to ‘inadequate’, high voltage contactor transitions from ‘closed’ to ‘open’, etc.), then method 200 may automatically stop the charge transfer process by sending a new command signal from hybrid control module 38 to power module 34, where the new command signal either reduces or ceases the flow of current through the power module without further user intervention.

Alternatively, step 238 could provide charge from high voltage battery unit 26 to low voltage battery unit 30 for as long as it takes battery pack 72 to attain a predetermined charge level. This status-based charge transfer condition (that is, the status on low voltage battery unit 26) may be a predetermined voltage threshold (e.g., 12 V), charge threshold, or some other value. While the voltage level may vary depending on the voltage rating of the particular low voltage battery unit 30 and the energy required for starting the hybrid electric vehicle, the threshold is generally met when the low voltage battery has enough energy to start the hybrid electric vehicle or ICE 16. In another embodiment, step 238 transfers charge from high voltage battery unit 26 to low voltage battery unit 30 through power module 34 for a certain amount of time. This time-based charge transfer condition can be used in lieu of or in combination with the other conditions mentioned above, and can be helpful when there is a concern that too much energy or charge will be taken from the high voltage battery. It should be appreciated that any combination of the preceding charge transfer conditions may be used to determine when to stop providing charge from the high voltage battery to the low voltage battery. In some instances, a single charge transfer condition may be used, in others a combination of charge transfer conditions could be used.

Once the charge transfer process has terminated or otherwise ended, hybrid control module 38 may send a command signal to power module 34 instructed it to turn ‘off’.

It is to be understood that the foregoing description is not a definition of the invention, but is a description of one or more preferred exemplary embodiments of the invention. The invention is not limited to the particular embodiment(s) disclosed herein, but rather is defined solely by the claims below Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For instance, the particular sequence or combination of steps in exemplary method 200 may be altered. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for starting a hybrid electric vehicle, the steps comprising:
(a) determining the status of a high voltage battery unit used for vehicle propulsion;
(b) determining the status of a low voltage battery unit used for starting the hybrid electric vehicle, wherein the high voltage battery unit generally has a higher voltage than the low voltage battery unit;
(c) determining if a user is attempting to start the hybrid electric vehicle; and
(d) if the status of the high voltage battery unit indicates that it is able to provide charge, the status of the low voltage battery unit indicates that it is in need of charge, and the user is attempting to start the hybrid electric vehicle, then providing charge from the high voltage battery unit to the low voltage battery unit to assist with starting the hybrid electric vehicle.

2. The method of claim 1, wherein step (a) further comprises receiving a high voltage battery signal that includes information regarding at least one of the voltage or the state of charge (SOC) of the high voltage battery from a sensor unit, and using the high voltage battery signal to determine if the high voltage battery unit is able to provide charge to the low voltage battery unit.

3. The method of claim 1, wherein step (b) further comprises receiving a low voltage battery signal that includes information regarding at least one of the voltage or the current of the low voltage battery from a sensor unit, and using the low voltage battery signal to determine if the low voltage battery unit is in need of charge.

4. The method of claim 1, wherein step (c) further comprises receiving an ignition signal from an ignition unit and using the ignition signal to determine if a user is attempting to start the hybrid electric vehicle.

5. The method of claim 1, wherein step (d) further comprises sending a command signal to a power module and using the command signal to control the duty cycle of the electrical current that is provided from the high voltage battery to the low voltage battery through the power module.

6. The method of claim 1, wherein step (d) further comprises continuing to monitor one or more charge transfer conditions to determine if any fault conditions have occurred, and if a fault condition has occurred then automatically stopping the provision of charge from the high voltage battery to the low voltage battery.

7. The method of claim 1, wherein step (d) further comprises continuing to monitor the status of the low voltage battery unit to determine if the low voltage battery unit attains a predetermined charge level, and if the low voltage battery unit attains the predetermined charge level then automatically stopping the provision of charge from the high voltage battery to the low voltage battery.

8. The method of claim 1, wherein step (d) further comprises keeping track of the amount of time that charge is transferred from the high voltage battery unit to the low voltage battery unit, and if the amount of time exceeds some predetermined limit then automatically stopping the provision of charge from the high voltage battery to the low voltage battery.

9. The method of claim 1, further comprising the step of:
receiving a power module signal from a power module and using the power module signal to determine the status of a propulsion system, wherein step (d) only provides charge from the high voltage battery unit to the low voltage battery unit if the propulsion system status is ‘inactive’.

10. The method of claim 1, further comprising the step of:
determining the status of a high voltage contactor, wherein step (d) only provides charge from the high voltage battery unit to the low voltage battery unit if the high voltage status is ‘closed’.

11. The method of claim 1, further comprising the step of:
determining the status of a power module, wherein step (d) only provides charge from the high voltage battery unit to the low voltage battery unit if the power module status is ‘adequate’.

12. The method of claim 1, further comprising the step of:
determining if an external power source is connected to the vehicle, wherein step (d) only provides charge from the high voltage battery unit to the low voltage battery unit if no external power source is connected to the vehicle.

13. A method of starting a hybrid electric vehicle, the steps comprising:
(a) determining the status of a high voltage battery unit used for vehicle propulsion;
(b) determining the status of a low voltage battery unit for starting the hybrid electric vehicle, wherein the high voltage battery unit generally has a higher voltage than the low voltage battery unit;
(c) if the status of the high voltage battery unit indicates that it is able to provide charge and the status of the low voltage battery unit indicates that it is in need of charge, then providing charge from the high voltage battery unit to the low voltage battery unit to assist with starting the hybrid electric vehicle; and
(d) monitoring one or more charge transfer conditions and using the charge transfer condition to automatically stop the provision of charge from the high voltage battery to the low voltage battery without further input from a user.

14. The method of claim 13, wherein step (d) further comprises continuing to monitor one or more charge transfer conditions to determine if any fault conditions have occurred, and if a fault condition has occurred then automatically stopping the provision of charge from the high voltage battery to the low voltage battery.

15. The method of claim 13, wherein step (d) further comprises continuing to monitor the status of the low voltage battery unit to determine if the low voltage battery unit attains a predetermined charge level, and if the low voltage battery unit attains the predetermined charge level then automatically stopping the provision of charge from the high voltage battery to the low voltage battery.

16. The method of claim 13, wherein step (d) further comprises keeping track of the amount of time that charge is transferred from the high voltage battery unit to the low voltage battery unit, and if the amount of time exceeds some predetermined limit then automatically stopping the provision of charge from the high voltage battery to the low voltage battery.

17. The method of claim 13, further comprising the step of:
receiving an ignition signal from an ignition unit and using the ignition signal to determine if a user is attempting to start the hybrid electric vehicle, wherein step (c) only provides charge from the high voltage battery unit to the low voltage battery unit if the user is attempting to start the vehicle.

18. The method of claim 1, further comprising the step of:
determining the status of a power module, wherein step (c) only provides charge from the high voltage battery unit to the low voltage battery unit if the power module status is ‘adequate’.

19. A system for use in a hybrid electric vehicle, comprising:
a high voltage battery unit for propelling the hybrid electric vehicle;
a first set of sensors coupled to the high voltage battery unit, the first set of sensors provides a high voltage battery signal that is representative of the status of the high voltage battery unit;
a low voltage battery unit for starting the hybrid electric vehicle;
a second set of sensors coupled to the low voltage battery unit, the second set of sensors provides a low voltage battery signal that is representative of the status of the low voltage battery unit;
an ignition unit coupled to the low voltage battery unit for starting the hybrid electric vehicle, the ignition unit provides an ignition signal that indicates when the hybrid electric vehicle is experiencing a starting event;
a power module coupled to the high and low voltage battery units; and
a control module coupled to the first set of sensors for receiving the high voltage battery signal, to the second set of sensor for receiving the low voltage battery signal, to the ignition unit for receiving the ignition signal, and to the power module for sending a command signal;
wherein if the high voltage battery signal indicates that the high voltage battery unit is able to provide charge, the low voltage battery signal indicates that the low voltage battery unit is in need of charge, and the ignition signal indicates that the hybrid electric vehicle is experiencing a starting event, then the control module uses the command signal to instruct the power module to provide charge from the high voltage battery unit to the low voltage battery unit.

20. The system of claim 19, wherein the high voltage battery unit stops providing charge to the low voltage battery unit when at least one of the following occurs:
the high voltage battery signal indicates that the high voltage battery can no longer provide charge, or the low voltage battery signal indicates that the low voltage battery is no longer in need of charge.
